(19) United States
(12) Patent Application Publication
(10) Pub. No.: US 2007/0130261 A1
(43) Pub. Date: Jun. 7, 2007

(54) Control/satellite electronic work station configurations in which stations interact among themselves on a real-time basis

(76) Inventor: Frances Jeanne Shaub, Austin, TX (US)

Correspondence Address: Frances Jeanne Shaub, 7, 11821 Bittern Hollow, Austin, TX, 78758, US

(21) Appl. No.: 11/286,857

(22) Filed: Nov. 26, 2005

(51) Int. Cl. G06F 15/16

(52) U.S. Cl. 709/205

(57) ABSTRACT

Interspersing switch interfaces amongst the keyboard, processor and monitor components of a standard electronic work station allows some flexibility of operation. When this concept is applied to a control-and-satellite electronic work station configuration the control station can share work area content and view screen display with each satellite station real-time and modify the work area content of a satellite station real-time. A central and satellite station can also query and answer each other real-time. In a classroom setting this configuration introduces one-on-one, custom instruction so each student can receive and execute his and her personal learning plan with teachers having an on-going window on each student's progress.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The main field of endeavor for this invention is education. The primary impetus for its origin is ordinary grade school classrooms, but you can apply it to any teaching endeavor. The subject matter of the invention involves teacher-student interaction using central and satellite electronic education stations and how the stations interact. The teacher uses the central station and preferably each student has his or her own satellite station.

Usually a classroom session runs along traditional lines: there's a teacher presentation and some Q/A exchange followed by a student exercise on the subject presented. Such an exercise is variable, anything from a pop quiz to a major construction project. A good teacher, or group instructor, has some idea of who are doing how well. Usually, “how well” covers a range of abilities and willingness to learn. But for classic instruction subjects (languages or mathematics, for examples) there's an inherent gap between presentation and student by student evaluation: how well each individual is absorbing the appropriate nitty-gritty.

Also, large classes inevitably work on a one-size-fits-all basis. Class members receive a standard presentation geared to an expected norm, where some students waste their time and some may remain irretrievably behind.

This invention is 1), a tool to bridge the evaluation gap, and 2), a method for each student to receive custom one-on-one instruction in any subject routinely.

### BRIEF SUMMARY OF THE INVENTION

The object of the central, or control, and satellite station configurations is to give instructors both a real-time, on-going assessment of student' grasp of a subject and an individual channel of communications for interaction with each student, and to give students in a given classroom the freedom to progress through subjects at their individual rates, acquiring whatever amount of knowledge at whatever rate they can or wish.

The control station can share content with (access) any satellite and can also display what is on any satellite view screen. The satellites usually operate independently of each other, and may be working on different material. The control station can correct or supplement (i.e., override) any satellite activity. Each satellite and the central unit can query each other and reply at any time. The net effect is that each student works at his or her own pace and the teacher can see what each student is doing and can correct or supplement the assignment activity.

These stations may operate by means of switches and various cabling configurations on off-the-shelf computer components. Descriptions are presented below.

### BRIEF DESCRIPTION OF SEVERAL VIEWS OF THE DRAWINGS

Not Applicable

### DETAILED DESCRIPTION OF THE INVENTION

This invention consists of control, or central, and associated electronic work stations. A control station can display on a view screen what is on an associated satellite view screen and also share the work content of that satellite station, and can override satellite content and display. A control and satellite can query and reply (Q/A) in real time (interactively). Satellites usually operate independently of one another, and also do not usually query-and-reply with each other. In the broadest operable scope of this concept, a central and a satellite station can access, act, and communicate with each other on and about the same content, the content being any entered text, graphics, and/or other medium that the station operating systems accommodate.

Further:
the satellites may each have open an individual copy of a common assignment or different assignments;
the satellites cannot access or Q/A each other unless freed by the central station and so designed;
if multiple screens are available at the central station, then more than one of the satellite' view screens can be displayed simultaneously at the central station;
this control-satellite interaction occurs on a real-time basis (i.e., the central station can access/display the work area content/view screen of any of the satellites immediately on putting in the satellite ID and this display can be ongoing);
again, the satellites and central station can link work area content (text, graphics, etc. from any source) real-time (i.e., open access, not file-limited); and further, the central station can vary the satellite work area content on the real-time basis.

A second configuration allows two or more control stations in the same assembly.

The preferred embodiment of this setup is in classrooms with students of varying abilities where the instructor operates the control station and the students use the satellites. The electronic stations themselves may be standard issue computer components (hard drives, memory units, monitors, keyboards, input/output ports and operating systems) with cabling and switches for this activity. And the class activities can include any subjects taught by common practice using documents, graphics, or even sound packages, web sites, and other media presented by new or existing software packages. A control and a satellite can query and reply interactively; and the control can modify the assignment content at a satellite, correcting or supplementing the student work. Satellites can each work on a separate assignment or on a common assignment, each with its own version. For the most part, one class will form its own control/satellite group, but this is flexible. Questions and answers can be typed text or audio, but entering onto view screens is preferable because, for example, typing out words and sentences is illustrative of a student's ability to crystallize ideas into words (logic, consistency, spelling, grammar, syntax, style, usage) and one's ability to focus on a given topic.

The concept described here may be a generic ideal of sharing a file. Whereas the phrase “file-sharing” usually refers to sending or copying a given quantum of text, graphics, sound, etc. to another user, the concept here applies to any body of material, electronically captured, which a leader then views along with a subordinate work-screen, accessing that material and optionally overriding that content.

The central-satellite principle is also useful wherever else formal instruction occurs, wherever instructors must convey specific information, ongoing or in batches;
language classes in any location
business offices
military centers
manufacturing facilities.

In any of these settings, the leader can not only teach but track the recipient' grasp and pace of learning.

In a collaborative setting, for instance an architectural project, several satellite station operators can coordinate through the control station to use a designated satellite as a common recipient of input. And, as previously observed, any text, graphic, sound package or other medium, which need not be “files,” can be subject to this equal, immediate-access method of operation.

Please note that video conference is a different situation. This invention is also separate from communication setups like language-study posts; electronic games, for instance those with locked-in programs on dedicated terminals; or online computer contests in which various players participate at the same time using immediate access from multiple stations to a common content of available options.

In some existing patents researchers describe networks of varying designs with control and subordinate electronics devices, and these may be targeted specifically to the field of education. One example of such a system is given in U.S. Pat. No. 6,895,213, which postulates the use of an electronic medium to give and grade tests. Classes have base and remote stations with the base receiving messages from the remote units. The system presented in U.S. Pat. No. 6,885,844 is a structured method of sending predetermined messages one way to a group leader. Here, the author networks devices to allow students to send to a base unit feedback on a presented topic. A student makes selections from available choices concerning the topic. The choices may include questions and comments, some of which may be drawn from the teaching material being presented. The transmittal is one-way, from the group's terminals to the base, except for optional preset responses to certain of the available choices.

In patents such as those cited above the authors use dominant and attendant stations and specific tasks, and they specifically describe the way the tasks are executed. By contrast, the application here addresses the framework in which all user tasks are carried out. Also, in patents such as those above the researchers utilize specific sets of available choices. In this application, users have as content any loadable electronic package.

The devices described in U.S. Pat. No. 6,895,214 also operate with optional contents, even those derived from outside sources, such as the internet. The devices are used to automatically monitor student terminal activity and interject educational material. This interjected material is pre-composed from various sources and is added to the student's work stream. However, the concept presented in the application here concerns a functioning control station by which the leader deliberately adds to, deletes, and/or modifies the subordinate station's intrinsic content. Also, the satellite components in this present application, including the keyboard, are only connected, as noted below, through intervening interfaces.

Although designed for use in ordinary classes, in practice, classes using the system here would work differently than with traditional school models. Traditional one-size-fits-all versus this system's custom instruction.

Most classroom activity is perforce one-size-fits-all. But people don't come that way. Skills differ widely. Ability levels within any skill varies. And people learn differently. Some acquire hard data easily. Some handle abstract concepts well. Some learn best by reading, others by graphics, still others by spoken prompts and give-and-take, or case histories. In the 20th century the burden for handling diversity was on one leader and that leader taught to a minimum common denominator of ability and achievement.

Instructors can work within the framework presented here to provide custom instruction to each of a group with an assortment of abilities and train each individual to his and her best condition. The base scenario has a teacher entering a test or assignment to all student stations. As the students proceed, they progress at their own paces. The control station can be used to enrich their activities as deemed fit. As work progresses through this package, the teacher can direct several iterations of instruction, each from a different learning process. Examples of different processes, as noted above, are applied examples, graphic illustration and an audible question set. This variety of tools, which can draw on content transmittable in at least three media, is more efficiently delivered through this assembly than standard teaching resources allow. All students can direct queries to the leader and vice versa as work progresses. The work can be varied, for example, a series of math problems or a project for building a cross-section of lithified storm-deposit stream bed strata.

If sufficient capability exists within the class equipment, the assignment content can be audible to students who can't see.

The control and satellite configuration will operate by means of an assembly of electronic stations analogous to, but different from, computer networks. The activity on the stations, any instructions or projects, may be content from current, off-the-shelf software or whatever is compatible with the station' operating systems; e.g., Excel spreadsheets will remain Excel spreadsheets and Green's math functions will remain Green's math functions. The innovation is the ability to access content and view displays and modify them. Switching from satellite to satellite is analogous to changing channels. People versed in common computer terminal use and software applications can assimilate and use the configurations described here.

As for the enabling equipment, existing cabling and switching equipment in any of a variety of designs can be used to deliver this product.

The easiest way to see a system for the activity described here is to start with a control station and one satellite. The satellite user's keyboard cabling runs through a switch to the satellite hard drive. The drive cabling leads to the control monitor and then in series to the satellite monitor. The control keyboard is connected to the satellite keyboard switch and when in use bypasses the satellite keyboard. So the control monitor displays what the satellite monitor displays, and the control keyboard overrides the satellite input strokes. However, it's more convenient to maintain a configuration in which the satellite can operate on an integral loop, so it is preferable to use a signal splitter between the satellite hard drive and the control monitor with the same signal sent to both the control monitor and satellite monitor. Thus, the control monitor displays what the satellite monitor displays, and the control keyboard can control the satellite hard drive and the open content there.

Also, in the latter design, the components use the standard ports; all added features, the signal splitter and the keyboard switch, are external to the basic station components.

For multiple satellites, satellite keyboard cables run through a switch at each satellite to that satellite hard drive. Each hard drive is cabled to a signal splitter. From there, each satellite signal is cabled: 1, back to the satellite monitor, and 2, to a selector package at which the person operating the control station can choose the substation to work with. A cable runs from the selector to a control monitor. The control keyboard also is connected through a selector package to a satellite keyboard switch of choice, and, when this connection is on, the satellite keyboard is bypassed.

Additionally, one or more of the channels at the selector package may integrate a control station's hard drive and keyboard with a control monitor for independent operation.

It is advisable for the control and satellite stations to have identical software packages or that these be as similar as practicable. Also, a mouse or similar device must be connected to coordinate with the designs herein described.

The control and satellite stations may query and reply (Q/A) to each other. The means and methods will depend on the resources of the operating systems. The means may be any email or other internetted technology installed as usual on the assembly components. Alternately, the operators can communicate using the text facility of an appropriate software application, word processing and desktop publishing being the most obvious. The method of communication from the control to a satellite station is in the use of the keyboard interrupt; if necessary, the satellite's open software or job must be closed and a communication facility activated. The satellite operator can also use internet facilities or alternatively signal the control leader to start an exchange by means of his satellite's sound system. If they are not in the same room, an external circuit for an audible or visible signal at the selector can be added.

There are other permutations in which this assembly can be hard-wired to perform as described. Also, custom wired hardware, when available, will be constructed with the keyboard and selector switches embedded into the other components. A wireless assembly with transmitted signals must maintain the basic features: control and satellite components are interspersed; and both control and satellite monitors must be able to have the same display, and the control station must be able to control the satellite hard drive.

Why has this not been done. Various reasons. Because most terminal assemblages have been designed to allow one user at a time to open an electronic package. Because most computer usage is geared to a station where the hard drive, keyboard and monitor are an indissoluble triad and any linkage to another work location connects the trio as a whole. Because few schools in primary education are sufficiently funded. Because few teachers are yet facile in the blossoming stream of electronic resources; many receive zero experience in computer basics unless they have their own computers. There are some existing options for the kind of interaction described above. These usually require that a group of terminals be “networked” (as commonly practiced). None of these assemblies presented in this application are so networked. The purpose here is to present an alternative that is cheaper than networking and the file server arrays available in industrial settings and easier to operate than the various levels of complexity in software resources now being marketed, and so more accessible and affordable to educators and their students.

What I claim as my invention is as follows:

1. An assembly of electronic work stations is presented in which each set of station components (entering medium, view screen, and processor or drive) are interspersed into a combined circuit with interfaces and the components of the other stations in the assembly.

2. The assembly of claim 1 is further configured into a control and plurality of satellite electronic work stations in which the satellite station components (entering medium, view screen, and processor or drive) are interspersed into a combined circuit with interfaces and the control station components.

3. In an alternate configuration of the setup in claim 2 there may be a plurality of control stations.

4. This configuration in claim 2 of control (or master or command) and satellite (or subordinate) electronic work stations lets the work area content of any satellite station be shared at the control station real-time, and the view screen of any satellite station can be displayed at the control station real-time.

5. The sharing of work area content cited in claim 4 allows the control and satellite stations to link work area content on an open access basis, not file-limited.

6. The sharing utilization cited in claim 4 may be limited to view screens only if this is preferred for a given application.

7. The control stations can also, through the interspersing cited in claim 2, modify the content that any satellite station has active real-time and interactively (i.e., delete, add, manipulate), the content being any entered text, graphics or other available medium from any electronic source; that is, any loadable electronic content.

8. The satellite stations may each have loaded a copy of a common project or have separate projects.

9. As an option, the control and satellite stations can query and answer each other, preferably by text, real-time, with or without a signal.

10. The satellite stations operate independently of each other unless a control frees them to interact with each other and if the group is designed to allow this interaction.

11. A control station may have a plurality of channels of operation independent of the satellite circuit(s).

12. In this application's method of operation, the satellite keyboard (or entering medium) connects to a switch and then to the satellite processor; the satellite processor signal is split to connect with both a control view screen and the satellite screen; the control keyboard (or entering medium) is also connected to the satellite keyboard switch and when this switch is so set the satellite keyboard is bypassed.

13. For a plurality of satellites, a satellite keyboard (or entering medium) connects to a switch and then to the satellite processor; the satellite processor signals, after splitting, are connected to a satellite screen and to a selector panel, and the control station operator can choose a satellite signal from the selector for interaction; the control keyboard (or entering medium) is also connected to the satellite keyboard switch through a selector panel and when this switch is so set the satellite keyboard is bypassed.
